(19) United States
(12) Patent Application Publication
(10) Pub. No.: US 2026/0357733 A1
(43) Pub. Date: Nov. 12, 2026

(54) DEVICE FOR HEATING EXHAUST GASES

(71) Applicant: Schaeffler Technologies AG & Co. KG, Herzogenaurach (DE)

(72) Inventors: Ferdi KURTH, Mechernich (DE); Sven SCHEPERS, Troisdorf (DE); Alexander REGLIN, Siegburg (DE); Jan HODGSON, Troisdorf (DE)

(21) Appl. No.: 19/130,601

(22) PCT Filed: Oct. 16, 2023
(86) PCT No.: PCT/EP2023/078613

§ 371 Date: May 16, 2025

(30) Foreign Application Priority Data
Nov. 17, 2022 (DE) 10 2022 212 260.7

(51) Int. Cl. F01N 3/20; F24H 3/04

(52) U.S. Cl. CPC F01N 3/2026; F24H 3/0452

(57) ABSTRACT

An apparatus for heating an exhaust gas flow in an exhaust gas line, having an electrically heatable heating matrix, a support structure connected to the heating matrix and a housing which spatially delimits the exhaust gas line and which can be flowed through in a main throughflow direction. The heating matrix has a plurality of flow channels which can be flowed through in the main throughflow direction of the housing. The housing has at an inner face thereof at least one shoulder which extends at least partially around in the circumferential direction and which projects in the radial direction inwardly from the inner face.

### CROSS REFERENCE TO RELATED APPLICATIONS

This is a U.S. national stage of Application No. PCT/EP2023/078613 filed Oct. 16, 2023. Priority is claimed on German Application No. DE 10 2022 212 260.7 filed Nov. 17, 2022, the contents of which are incorporated herein by reference.

### BACKGROUND OF THE INVENTION

### 1. Field of the Invention

The disclosure relates to an apparatus for heating an exhaust gas flow in an exhaust gas line, having an electrically heatable heating matrix, having a support structure that is connected to the heating matrix and having a housing which spatially delimits the exhaust gas line and which can be flowed through in a main throughflow direction, wherein the heating matrix has a plurality of flow channels which can be flowed through in the main throughflow direction of the housing.

### 2. Description of the Related Art

Nowadays, electrical heating elements are often used to heat exhaust gases in an exhaust gas line downstream of an internal combustion engine, or the exhaust gas flowing in an exhaust gas line. The aim here is to more quickly reach a temperature threshold from which effective transformation of the pollutants entrained in the exhaust gas can take place. This is necessary because the catalytically active surfaces, used for exhaust gas aftertreatment, of the catalytic converters installed in the exhaust gas line only allow sufficient conversion of the respective pollutants from a minimum temperature, known as the light-off temperature.

The known solutions in the prior art include what are known as heated catalytic converters, which have a metallic structure connected to a voltage source or a metal-coated ceramic structure which can be heated up by exploiting ohmic resistance.

The heatable metal structures may comprise, for example, a honeycomb body which is produced from metal foils. To this end, a plurality of smooth and/or at least partially structured metal foils are stacked one on the other and wound about at least one rotation location to form a honeycomb body. The matrix formed from the metal foils can be electrically contacted and heated up by exploiting ohmic resistance.

To this end, the matrix must be arranged in an exhaust gas line and be arranged upstream or downstream of a catalytic converter which is configured for exhaust gas aftertreatment in the flow direction of the exhaust gas.

In order to position the matrix in the exhaust gas line and to support it in particular against mechanical and thermal loads, which occur in particular with the high thermal alternating loads and furthermore with the powerful and irregular mechanical loads in an exhaust gas line, in particular the exhaust gas line of a motor vehicle, there must be provided a retention member. The support structure must be securely positioned in the exhaust gas line. To this end, the support structure must be secured to the housing of the exhaust gas line.

A disadvantage in known solutions in the prior art is particularly that the known attachment types do not allow an optimum connection between the support structure and the housing and there is a need for improvement with particular regard for the durability.

### SUMMARY OF THE INVENTION

Therefore, an object of one aspect of the present invention is to provide an apparatus for heating exhaust gases that allows the heating matrix to be positioned securely and durably in a housing of the exhaust gas line and to be permanently fixed.

One exemplary embodiment of the invention relates to an apparatus for heating an exhaust gas flow in an exhaust gas line, having an electrically heatable heating matrix, having a support structure connected to the heating matrix and having a housing which spatially delimits the exhaust gas line and can be flowed through in a main throughflow direction, wherein the heating matrix has a plurality of flow channels which can be flowed through in the main throughflow direction of the housing, wherein the housing has at the inner face thereof at least one shoulder which extends at least partially around in the circumferential direction and which projects in the radial direction inwardly from the inner face.

The housing of an exhaust gas line is, particularly in automotive manufacturing, regularly formed by pipelines, which have a circular cross section. A heating matrix is formed, for example, by a metal honeycomb body formed from a plurality of metal foils. In this case, the metal foils are smooth and/or at least partially structured, in particular undulating, and are stacked one on the other to form a stack of layers and wound about at least one rotation location. There is thereby produced a honeycomb body which forms a plurality of flow channels between the metal foils. Via a corresponding electrical contacting, the honeycomb body can be energized and heated using the ohmic resistance. The exhaust gas that flows through the honeycomb body is heated and consequently other catalytic converters which are located in the exhaust gas line, preferably downstream in the flow direction, can be heated more quickly and brought to their individual light-off temperature, from which the complete conversion of exhaust gases, catalytic conversion, is carried out.

The heating matrix is connected to a support structure, for example, using support pins, in a durable manner. Depending on the application, the heating matrix can be electrically insulated from the support structure here. The support structure itself has a grid-like structure which has sufficient attachment locations for the heating matrix over a cross section of the heating matrix in order to support the heating matrix securely and in a protected manner against mechanical and thermal loads. At the same time, the support structure is constructed in such a manner that the pressure loss which is produced for the exhaust gas flowing past is as small as possible.

The support structure further has an annular region, from which individual struts project radially inwardly. The annular region forms together with the struts the grid-like structure. The annular region can preferably be formed so as to extend all the way around as a closed ring. This region serves to connect the support structure to the housing.

According to one aspect of the invention, the housing has a shoulder that extends at least partially around in the circumferential direction. This shoulder acts as an abutment location for the support structure, in particular an annular region of the support structure. The support structure can be placed in the housing and against the shoulder during assembly and, for example, be connected to the shoulder of the housing by a soldering method. The shoulder can preferably be formed at a precisely defined position and thus allow precise positioning of the support structure and consequently of the heating matrix.

It is particularly advantageous if the shoulder is formed so as to extend completely around. A shoulder extending completely around the housing in the circumferential direction is advantageous in order to provide a support surface which is as large as possible between the support structure and the shoulder and thus to provide a particularly stable connection. This particularly helps the support structure and consequently also the heating matrix with respect to powerful shocks and the powerful temperature changes which necessarily occur in an exhaust gas line. Furthermore, vibration states of the heating matrix and the support structure which are determined, for example, by the respective natural frequencies of the bodies, can be reduced by a particularly secure connection.

It is also advantageous if the shoulder is formed by an inner pipe which is inserted in the housing. Preferably, an inner pipe with a correspondingly smaller outer diameter can be pressed into the pipe that forms the housing. The shoulder, which acts as an abutment location, is thereby formed in a simple manner. As a result of controlled pressing in, the position of the shoulder can be determined very precisely, whereby in particular the production of negative tolerance chains can be avoided.

When the materials are selected, it is preferable for the housing and the inner pipe to be made from the same material. This prevents negative influences, for example, as a result of different thermal expansion coefficients which may lead, for example, to mechanical stresses.

A preferred exemplary aspect is characterized in that the shoulder is produced by deformation of the housing. Alternatively, the shoulder can be formed by deforming the housing. To this end, for example, beads can be pressed into the housing from the outer side. In this case, the beads can be formed completely or only partially in the circumferential direction. In particular, a plurality of beads can be formed with spacing from each other in the circumferential direction.

It is also preferable for the housing to have two shoulders that are formed with spacing from each other in the main throughflow direction. This is brought about in a simple manner, by a pressed-in inner pipe which forms two shoulders which are orientated in opposite directions. The shoulders which are formed by a pipe thus have an abutment face in the main throughflow direction and an abutment face which is orientated counter to the main throughflow direction. Two shoulders have the advantage that the heating matrix can be supported in a two-fold manner by the support structure being formed at both sides of the heating matrix.

Furthermore, it is advantageous if the support structure has a first annular outer region, the outer diameter of which is smaller than the inner diameter of the housing, wherein the inner diameter of the portion, which is formed by the shoulder, of the housing is smaller than the outer diameter of the first annular outer region of the support structure. The support structure can thereby be readily inserted into the housing and positioned on the formed shoulder. As a result of the corresponding size relationships, it becomes impossible to fall past the shoulder. This simplifies the capacity for production. In addition to the shoulder, there can be provided in the pipe of the housing positioning elements for positioning the support structure which are formed, for example, by projections.

It is further advantageous if the support structure has a second annular outer region, wherein the first annular outer region is arranged upstream of the heating matrix in the main throughflow direction and the second annular outer region is arranged downstream of the heating matrix in the main throughflow direction. This allows an improved positioning and fixing of the heating matrix with respect to the pipe. For the purposes of assembly, the heating matrix can be connected to one half of the support structure and then inserted into the housing. The heating matrix is then connected to the second half of the support structure which is brought into abutment with the second shoulder in the housing during the connection to the heating matrix. Finally, both pieces of the support structure can be connected to the shoulders of the housing by a suitable method.

It is also advantageous if the housing forms a plurality of shoulders, wherein they are arranged in a plane of section of the housing in a state spaced apart from each other in the circumferential direction of the housing.

Advantageous developments of the present invention are described in the dependent claims and in the description of the figures that follows.

### BRIEF DESCRIPTION OF THE DRAWINGS

The invention is explained in detail below with reference to exemplary embodiments and the drawings, in which:

FIG. 1 is a sectioned view through a housing with a pressed-in inner pipe;

FIG. 2 is a sectioned view through a housing with a support structure; which abuts an inner pipe, and a heating matrix; and

FIG. 3A is a schematic view of a housing with a configuration of shoulders which have been produced by deforming the housing.

FIG. 3B is a schematic view of a housing with a configuration of shoulders which have been produced by deforming the housing.

### DETAILED DESCRIPTION OF THE PRESENTLY PREFERRED EMBODIMENTS

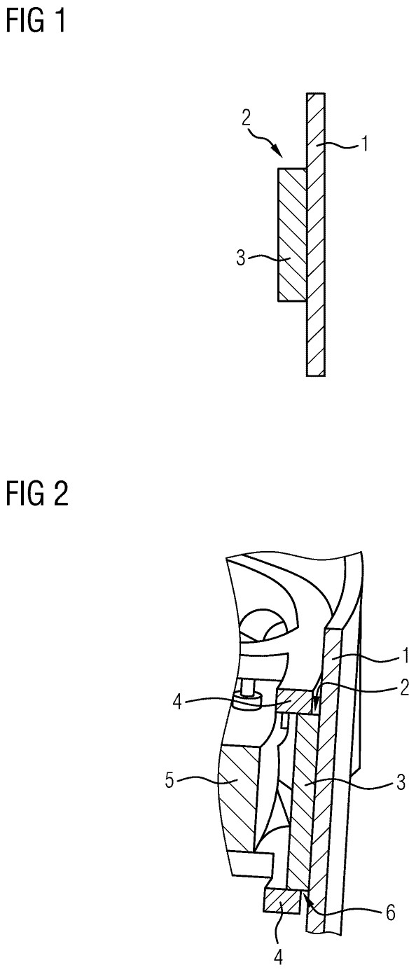

FIG. 1 shows a sectioned view through a housing 1, which is formed by a pipe. In order to produce a shoulder 2 which forms an abutment face for a support structure which is not shown, an inner pipe 3 is pressed into the housing 1. The inner pipe 3 has such dimensions with respect to its diameter that a play-free, durable retention between the inner pipe 3 and the housing 1 is formed by the pressing-in action.

FIG. 2 shows a sectioned view through the housing 1 with the inner pipe 3 pressed in. A support structure 4 which is positioned in a planar manner on the abutment face, which is formed by the shoulder 2, is shown on the shoulder 2.

The support structure 4 is connected to a heating matrix 5 which is positioned securely in the housing 1 by the support structure 4 being positioned on the shoulder 2. The support structure 4 is connected to the inner pipe 3 in a durable manner preferably by a soldering method.

In FIG. 2, the heating matrix 5 is retained at both sides of the inner pipe 3 by a portion of the support structure 4 and the support structure 4 is in abutment with both shoulders 2, 6 which are formed by the inner pipe 3. In this manner, the heating matrix 5 is fixed at two positions with respect to the housing 1.

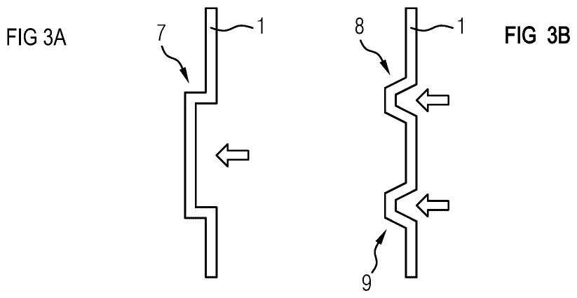

FIGS. 3A and 3B shows two different aspects of a housing 1. The pipe which forms the housing 1 has been processed by a deformation method and forms at the inner face thereof shoulders 7, 8, 9. The shoulders 7, 8, 9 are formed by beads which have been formed in the housing 1 from the outer side. The shoulders 7, 8 and 9 shown in FIGS. 3A and 3B in section can be formed in the circumferential direction in a manner extending completely around the housing 1 or only in portions and with spacing from each other in the circumferential direction. In any case, however, the shoulders 7, 8 and 9 are located in one plane of section.

The exemplary embodiments of FIGS. 1 to 3 particularly do not have any limiting character and serve to explain the notion of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. An apparatus for heating an exhaust gas flow in an exhaust gas line, comprising:
a housing which spatially delimits the exhaust gas line and which can be flowed through in a main throughflow direction, wherein the housing has, at an inner face, at least one shoulder which extends at least partially around in a circumferential direction and which projects in a radial direction inwardly from the inner face;
a heating matrix that is electrically heatable, wherein the heating matrix has a plurality of flow channels which can be flowed through in the main throughflow direction of the housing; and
a support structure which is connected to the heating matrix;

10. The apparatus as claimed in claim 9, wherein the at least one shoulder is formed so as to extend completely around the housing.

11. The apparatus as claimed in claim 9, wherein the at least one shoulder is formed by an inner pipe which is inserted in the housing.

12. The apparatus as claimed in claim 9, wherein the at least one shoulder is produced by deformation of the housing.

13. The apparatus as claimed in claim 9, wherein the housing has two shoulders which are formed with spacing from each other in the main throughflow direction.

14. The apparatus as claimed in claim 9,
wherein the support structure has a first annular outer region, an outer diameter of the first annular outer region is smaller than an inner diameter of the housing, and
wherein a portion of the inner diameter, which is formed by the at least one shoulder, of the housing, is smaller than the outer diameter of the first annular outer region of the support structure.

15. The apparatus as claimed in claim 14, wherein the support structure has a second annular outer region, wherein the first annular outer region is arranged upstream of the heating matrix in the main throughflow direction and the second annular outer region is arranged downstream of the heating matrix in the main throughflow direction.

16. The apparatus as claimed in claim 9, wherein the housing forms a plurality of shoulders, wherein the plurality of shoulders are arranged in a plane of section of the housing in a state spaced apart from each other in the circumferential direction of the housing.
